(19) United States
(12) Patent Application Publication
(10) Pub. No.: US 2015/0044511 A1
(43) Pub. Date: Feb. 12, 2015

(54) BATTERY PACK

(71) Applicant: SAMSUNG SDI CO., LTD., Yongin-si (KR)

(72) Inventors: Kiwoong KIM, Yongin-si (KR); Jacky CHOI, Yongin-si (KR)

(73) Assignee: SAMSUNG SDI CO., LTD., Yongin-si (KR)

(21) Appl. No.: 14/203,966

(22) Filed: Mar. 11, 2014

Related U.S. Application Data
(60) Provisional application No. 61/863,614, filed on Aug. 8, 2013.

(51) Int. Cl. H01M 10/42

(52) U.S. Cl. CPC H01M 10/425
USPC 429/7

(57) ABSTRACT

A battery pack includes at least one battery cell having a first conductive tab and a second conductive tab, a protection circuit board electrically connected to the first and second conductive tabs, and a temperature sensitive element on the protection circuit board. The temperature sensitive element is adjacent, but electrically insulated from, a connection region where at least one of the first and second conductive tabs is connected to the protection circuit board, the connection region being between the temperature sensitive element and the battery cell.

### CROSS-REFERENCE TO RELATED APPLICATION

The present application claims priority under 35 U.S.C. §119 to U.S. Provisional Application No. 61/863,614 filed on Aug. 8, 2013, and entitled: “Battery Pack,” which is incorporated herein by reference in its entirety.

### BACKGROUND

1. Field

Embodiments relate to a battery pack, which can be easily manufactured and accurately can measure the temperature of a battery cell.

2. Description of the Related Art

In general, secondary batteries are chargeable and dischargeable to be repeatedly used and are widely used for cellular phones, notebook computers, cameras, camcorders, hybrid vehicles, electric vehicles, or electric scooters. In order to be employed to a high-output requiring device, the secondary batteries are manufactured in the form of a battery pack including a plurality of battery cells. Here, the plurality of battery cells are generally electrically connected by a connection member such as a wire or a nickel plate

Various temperature elements for measuring temperatures of battery cells to control charging and discharging are mounted together in the battery pack. In addition, the temperature elements need to be electrically connected to a protection circuit board, and the temperatures of the battery cells should be accurately measured.

### SUMMARY

One or more embodiments is directed to as battery pack including at least one battery cell having a first conductive tab and a second conductive tab, a protection circuit board electrically connected to the first and second conductive tabs, and a temperature sensitive element on the protection circuit board adjacent, but electrically insulated from, a connection region where at least one of the first and second conductive tabs is connected to the protection circuit board, the connection region being between the temperature sensitive element and the battery cell.

The second conductive tab may output more heat than the first conductive tab and no other thermally radiating elements may be between the temperature sensitive element and the second conductive tab.

The second conductive tab may be a negative electrode tab and the temperature sensitive element may be closer to the negative electrode tab than to a positive electrode tab.

A smallest distance between the temperature sensitive element and the connection region is equal to or less than 3 mm.

The at least one battery cell may include, a. plurality of battery cells connected to each other, the first conductive tab being a high current line connecting adjacent battery cells and the second conductive tab being a sensing line connecting adjacent battery cells.

The temperature sensitive element may be closer to the sensing line than to the high current line.

The battery pack may include a thermally conductive pattern extending from the connection region of the sensing line towards, but not contacting, the temperature sensitive element.

The thermally conductive pattern may be narrower than the connection region.

The connection region may be a first thermally conductive pattern on a first surface of the protection circuit board and the temperature sensitive element may be on one of the first surface and a second surface of the protection circuit board.

The battery cell may include a second thermally conductive pattern on the second surface, the temperature sensitive element being adjacent, but electrically insulated from, the second thermally conductive pattern, and thermally conductive vias extending through the protection circuit board between the first thermally conductive pattern and the second thermally conductive pattern.

At least one of the temperature sensitive element and the second thermally conductive pattern may include a thermally conductive silicon therebetween.

The battery pack may include thermally conductive vias extending through the protection circuit board to thermally couple the temperature sensitive element and the connection region.

The battery cell may include a second thermally conductive pattern on the second surface, the temperature sensitive element being adjacent, but electrically insulated from, the second thermally conductive pattern, wherein the thermally conductive vias extend between the first thermally conductive pattern and the second thermally conductive pattern.

The temperature sensitive element may be spaced apart from the second thermally conductive pattern by 3 mm or less.

The temperature sensitive element may be in physical contact with the thermally conductive vias.

The temperature sensitive element may be in physical contact with the thermally conductive vias without electrical contact there between.

The battery cell may include a thermally conductive silicon between the temperature sensitive element and the protection circuit board.

The thermally conductive silicon may extend along both ends of the temperature sensitive element parallel the connection region.

The temperature sensitive element may include a thermally conductive silicon between the temperature sensitive element and the connection region.

The temperature sensitive element may be a thermistor.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view of a battery pack according to an embodiment;

FIG. 2 illustrates an exploded perspective view of a state in which a thermistor is connected to a protection circuit board in the battery pack shown in FIG. 1;

FIG. 3 illustrates an exploded perspective view of a battery pack according to another embodiment;

FIG. 4 illustrates a plan view of a state in which a thermistor is connected to a protection circuit board in the battery pack shown in FIG. 3;

FIG. 5 illustrates a plan view of a state in which a thermistor is connected to a protection circuit board in a battery pack according to still another embodiment,

FIG. 6 illustrates a cross-sectional view of a state in which a thermistor is connected to a protection circuit board in a battery pack according to still another embodiment; and

FIG. 7 illustrates a cross-sectional view of a state in which a thermistor is connected to a protection circuit board in a battery pack according to still another embodiment.

### DETAILED DESCRIPTION

Example embodiments will now be described in more detail with reference to accompanying drawings, such that those skilled in the art can easily practice the present invention.

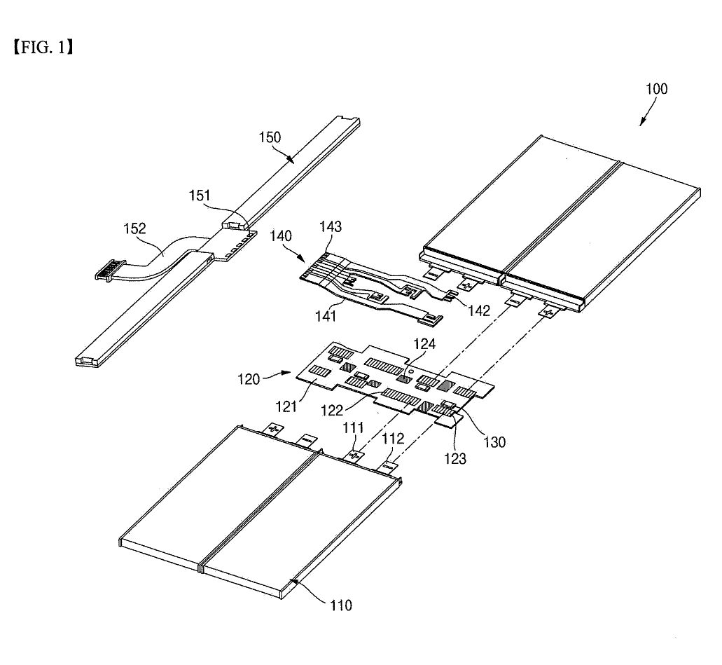

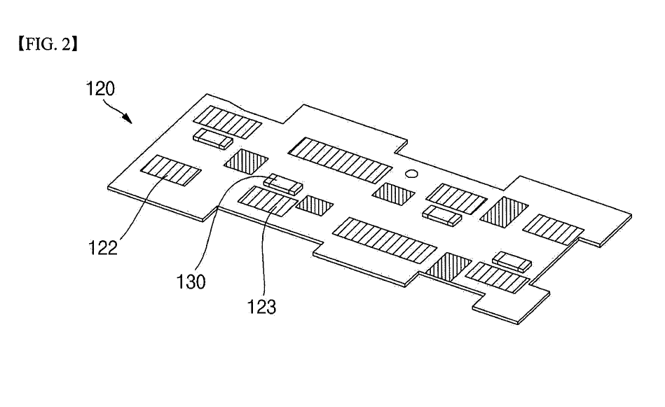

FIG. 1 illustrates an exploded perspective view of a battery pack according to an embodiment. FIG. 2 illustrates an exploded perspective view of a state in which a thermistor is connected to a protection circuit board in the battery pack shown in FIG. 1.

Referring to FIGS. 1 and 2, the battery pack 100 according to an embodiment of the present invention includes at least one battery cell 110, a protection circuit board 120, a thermistor 130, and a flexible printed circuit board 140. In addition, the battery pack 100 according to an embodiment may further include a circuit module 150 connected to the flexible printed circuit board 140.

The battery cell 110 performs a discharging operation of supplying power to an external load and a charging operation of receiving power from a charger, etc. The battery cell 110 may be provided as at least one prismatic battery. In the embodiment of the present invention, the at least one battery cell 110 is provided as four battery cells, but the present invention does not limit the number of the battery cells 110. The number of battery cells 110 can be adjusted according to a desired output.

Each of the battery cells 110 may include an electrode assembly including a positive electrode plate, a negative electrode plate and a separator interposed between the positive electrode plate and the negative electrode plate accommodated with an electrolytic solution, and a positive electrode tab 111 and a negative electrode tab 112 electrically connected to the electrode assembly and exposed to the outside of the battery cell 110.

Although not shown, the positive electrode tab 111 may include a general thermal cut-off (TCO). The TCO is a device that cuts off the flow of current when the temperature of the positive electrode tab 111 exceeds an allowable temperature level. In the battery pack 100 according to an embodiment of the present invention, charging and discharging operations are stopped at a high temperature exceeding the allowable temperature level due to over-charge or over-discharge, thereby achieving safety of the battery pack 100.

The protection circuit board 120 is formed at a region corresponding to electrode tabs 111 and 112 of the battery cell 110 to overlap with the electrode tabs 111 and 112 of the battery cell 110 to then be connected thereto. The protection circuit board 120 is electrically connected to the battery cell 110. The protection circuit board 120 may be a rigid printed circuit board or a flexible printed circuit board according to the option made by one skilled in the art.

To this end, the protection circuit board 120 basically includes an insulation layer 121 shaped of a plate and includes a first coupling unit 122 and a second coupling unit 123 formed on its one surface. The first coupling unit 122 is connected to a positive electrode tab 111 of the battery cell 110 and the second coupling unit 123 is connected to a negative electrode tab 112 of the battery cell 110. In the battery cell 110, the positive electrode tab 111 and the negative electrode tab 112 are generally positioned on the first coupling unit 122 and the second coupling unit 123 of the protection circuit board 120 to then be connected thereto by soldering or welding, but embodiments are not limited thereto.

The circuit module 150 provided on one surface of the protection circuit board 120 may also be electrically connected to the thermistor 130 positioned in the vicinity of the second coupling unit 123. Therefore, as will later be described, a signal of measuring a temperature of the battery cell 110 sensed by the thermistor 130 may be transferred to the circuit module 150 through a pattern of the protection circuit board 120.

The protection circuit board 120 may further include a third coupling unit 124 on its one surface to be connected to the flexible printed circuit board 140. The third coupling unit 124 is formed in number to correspond to terminals of the flexible printed circuit board 140. The flexible printed circuit board 140 may also be positioned in the third coupling unit 124 to then be connected by welding or soldering, but embodiments are not limited thereto.

The thermistor 130 may measure the temperature of the battery cell 110 using resistive components varying according to temperature. The thermistor 130 may be a positive temperature coefficient (PTC) thermistor or a negative temperature coefficient (NTC) thermistor. The thermistor 130 may be a provided as a chip thermistor so as to provide an electrical connection without a wire.

The thermistor 130 may be formed on one surface of the protection circuit board 130. Specifically, the thermistor 130 may be formed in the vicinity of the second coupling unit 123 of the protection circuit board 130. The thermistor 130 may be formed in the vicinity of the negative electrode tab 112 of the battery cell 110 coupled to the second coupling unit 123. In particular, the thermistor 130 may be positioned at a distance of 3 mm or less from the negative electrode tab 112. in this case, the temperature of the battery cell 110 can be accurately sensed from the negative electrode tab 112. In addition, since the temperature of the battery cell 110 can be more accurately as the thermistor 130 gets closer to the negative electrode tab 112, a lower limit of the distance between the thermistor 130 and the negative electrode tab 112 is not separately defined.

In a case where a general thermal cut-off (TCO) is formed in the positive electrode tab 111 of the battery cell 110, a spatial limitation in installing the thermistor 130 may be generated due to presence of the TCO. In addition, if heat of the TCO is sensed by the thermistor 130, accurate measurement of the temperature of the battery cell 110 may not be obtained. In addition, in general, the negative electrode tab 112 generates a larger amount of heat than the positive electrode tab 111. Thus, the thermistor 130 may be formed to be closer to the negative electrode tab 112 than to the positive electrode tab 111.

In addition, although not separately illustrated, thermally conductive silicon may further be formed at outer peripheries of the thermistor 130 and the negative electrode tab 112 of the battery cell 110. Therefore, compared to air which is typically therebetween, the heat of the negative electrode tab 112 can be transferred to the thermistor 130 without loss, thereby more accurately measuring the temperature.

The flexible printed circuit board 140 may be coupled to the third coupling unit 124 on one surface of the protection circuit board 120. The flexible printed circuit board 140 may basically include an insulation layer 141 having a plurality of first terminals 142 formed at a first end thereof and a plurality of second terminals 143 formed at a second end thereof. The first terminals 142 correspond to and are connected to the third coupling unit 124 of the protection circuit board 120. The second terminals 143 correspond to and are connected to corresponding regions of the circuit module 150, respectively, In such a manner, the flexible printed circuit board 140 electrically connects the protection circuit board 120 and the circuit module 150 to each other.

The circuit module 150 may include a plurality of conductive pads 151 that contact the plurality of second terminals 143 to electrically connect the circuit module 150 to the flexible printed circuit board 140. The circuit module 150 is electrically connected to the battery cell 110 through the flexible primed circuit board 140 and the protection circuit board 120. Although not shown, the circuit module 150 may include a circuit formed on an insulating substrate to enable charging and discharging of the battery cell 110, and a protection circuit for preventing the battery cell 110 from being over-charged or over-discharged. In addition, the circuit module 150 may include a connecting unit 152 installed to be electrically connected to an external load or an external electric device such as a charger. The insulating, substrate constituting the circuit module 150 may be as rigid board.

Hereinafter, a configuration of a battery pack according to another embodiment will be described.

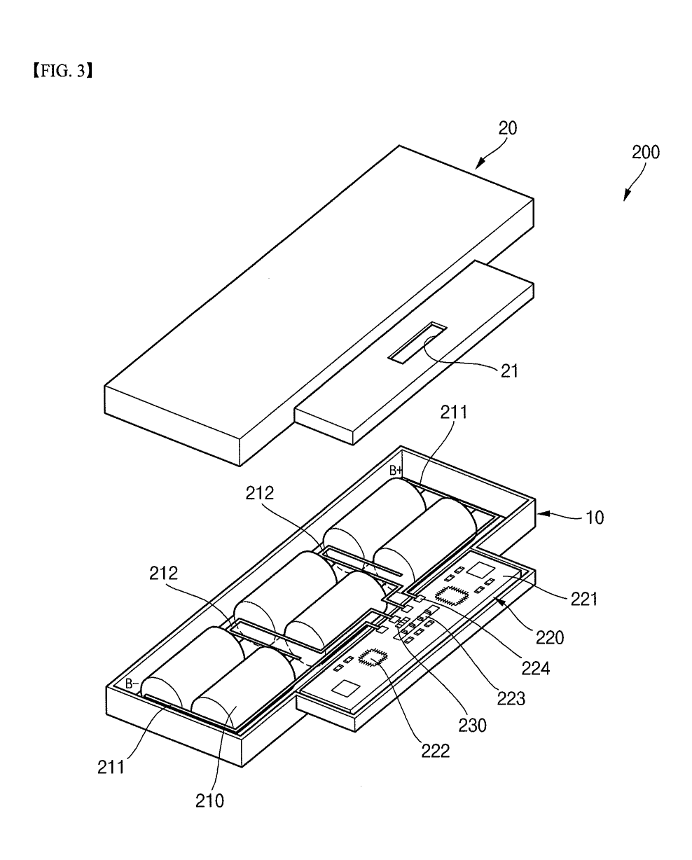

FIG. 3 illustrates an exploded perspective view of a battery pack according to another embodiment and FIG. 4 illustrates a plan view of a state in which a thermistor is connected to a protection circuit board in the battery pack shown in FIG. 3. The same configurations and the same functional components are denoted by the same reference numerals of the previous embodiment, and the following description will focus on differences between the present and previous embodiments.

Referring to FIGS. 3 and 4, the battery pack 200 according to another embodiment includes at least one battery cell 210 provided in a case having a lower case 10 and an upper case 20, a protection circuit board 220 electrically connected to the battery cell 210, and a thermistor 230 provided in the protection circuit board 120.

The battery cell 210 is a cylindrical battery with top and bottom surfaces have different polarities. The top surface of the battery cell 210 may be electrically connected to a positive electrode of an electrode assembly (not shown) in the battery cell 210 and the bottom surface of the battery cell 210 may be electrically connected to a negative electrode of the electrode assembly. In FIG. 3, B+ and B− indicated at opposite ends of battery cells 210 connected in series/parallel refer to high current terminals.

In addition, conductive tabs 211 and 212 may be connected between the battery cell 210 connected to each other. The conductive tabs 211 and 212 connect positive electrodes and negative electrodes of the battery cells 210 laterally positioned in parallel to establish parallel connections between the battery cells 210. In addition, the conductive tabs 211 and 212 are positioned between the battery cell 210 longitudinally adjacent to each other or between each of the battery cells 210 and the protection circuit board 220 to establish serial connections between the battery cells 210. The conductive tabs 211 and 212 may be made, e.g., nickel (Ni) copper (Cu), aluminum (Al), gold (Au) and equivalents thereof. The conductive tabs 211 and 212 may be substantially ‘U’ shaped, thereby stably connecting the battery cells 210 using elastic forces. However, conductive tabs 211 and 212 having shapes different from that illustrated may be employed. For example, the conductive tabs 211 and 212 may simply be plates.

Since the conductive tabs 211 and 212 are thermally conductive, heat generated from the battery cells 210 can be easily transferred without loss. Therefore, as will later be described, the conductive tabs 211 and 212 transfer the heat generated from the battery cells 210 to the thermistor 230 positioned in the vicinity of the conductive tabs 211 and 212, thereby accurately measuring the temperature of the battery cells 210.

The conductive tabs 211 and 212 may include high current lines 211 positioned at opposite ends and sensing lines 212 positioned between the battery cells 210 connected to each other. The high current lines 211 are connected to the protection circuit board 220 via connection regions 224 and provide a path for applying charging/discharging current of the overall battery cells 210. The high current lines 211 may also sense all voltage and current signals of the battery cell 210 to transfer the sensed signals to the protection circuit board 220. The sensing lines 212 are connected to the high current lines 211 among the conductive tabs 211 and 212 of the battery cell 210, except for the outermost high current lines 211. The sensing lines 212 may transfer the voltage signals between the battery cells 210 connected to each other to the protection circuit board 220, via connection regions 226 thereby allowing the protection circuit board 220 to identify voltage values of the battery cells 210 connected in series.

The protection circuit board 220 may be provided in the internal space of the lower case 10. The protection circuit board 220 may include wiring patterns formed on at least one surface of a planar insulation layer 221 and at least one semiconductor device 222 formed on the one surface of a planar insulation layer 221. in addition, the protection circuit board 220 may include a connector 223 provided on the one surface to be connected to an external device.

The protection circuit board 220 is electrically connected to the battery cell 210 through the conductive tabs 211 and 212. Therefore, the protection circuit board 220 may control charging and discharging of the conductive tabs 211 and 212.

Like in the previous embodiment, the thermistor 230 may be provided as a chip thermistor and formed on one surface of the protection circuit board 220. Specifically, the thermistor 230 may be formed on the one surface of the protection circuit board 220 in the vicinity of the sensing lines 212 of the conductive tabs 211 and 212. The thermistor 230 may be formed to be spaced a distance of 3 mm or less apart from the sensing lines 212. If the thermistor 230 is spaced less than 3 mm apart from the sensing lines 212, as described above in the previous embodiment the heat transferred from the battery cell 210 through the sensing lines 212 can be easily sensed. In addition, thermally conductive silicon may further be formed at ends of the sensing lines 212 and the outer periphery of the thermistor 230, thereby reducing the loss of twat transferred to the thermistor 230.

Alternatively, the high current lines 211, instead of the sensing lines 212, may serve as a thermal conductor for the battery cell 210, thereby transferring heat to the thermistor 230. However, since the high current lines 211 are wider than the sensing lines 212, heat loss may be generated at the high current lines 211.

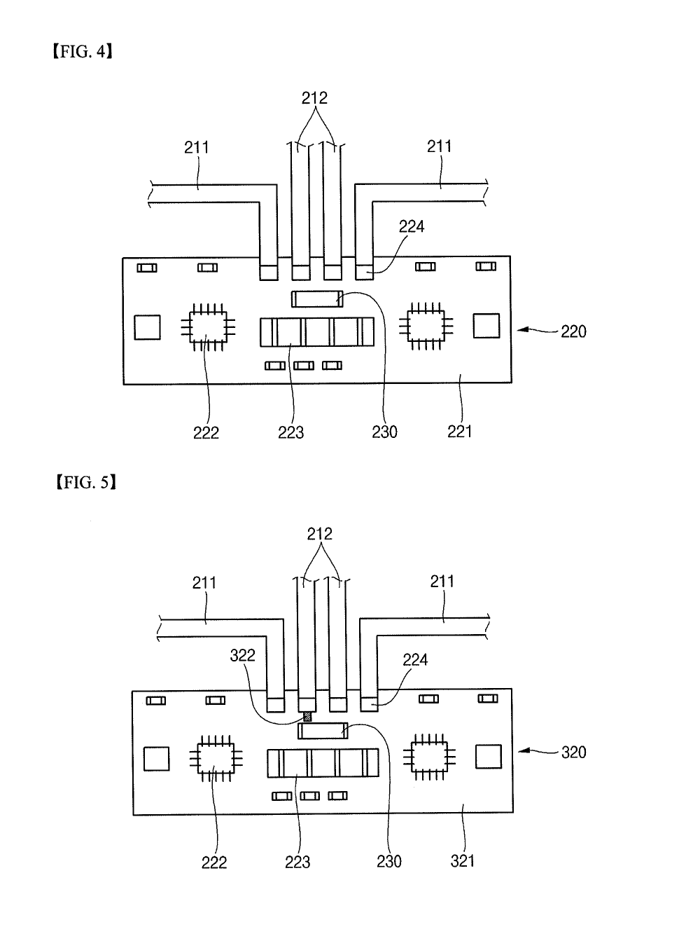

Hereinafter, a configuration of a battery pack according to still another embodiment will be described. FIG. 5 illustrates a plan view of a state in which a thermistor is connected to a protection circuit board in a battery pack according to still another embodiment.

Referring to FIG. 5, the battery pack according to still another embodiment includes at least one battery cell (not shown), a protection circuit board 320 electrically connected to the battery cell, and a thermistor 230 provided in the protection circuit board 320.

The protection circuit board 320 includes a thermally conductive pattern 322 on a first surface of an insulation layer 321, the thermally conductive pattern 322 extending from regions of conductive tabs 211 and 212 corresponding to lower portions of sensing lines 212 toward the thermistor 230. The thermally conductive pattern 322 may be made of a material having good thermal conductivity, e.g., nickel (Ni), copper (Cu), aluminum (Al), gold (Au), and equivalents thereof. The thermally conductive pattern 322 transfers the heat from the sensing lines 212 to a region near the thermistor 230 or to a lower portion of the thermistor 230, thereby allowing the thermistor 230 to accurately measure the temperature of the battery cell without heat loss.

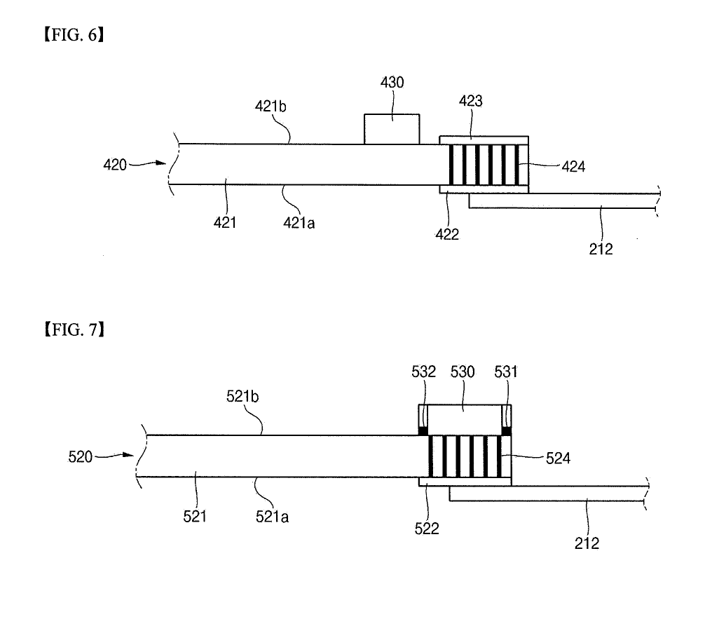

Hereinafter, a configuration of a battery pack according to still another embodiment will be described. FIG. 6 illustrates a cross-sectional view of a state in which a thermistor is connected to a protection circuit board in a battery pack according to still another embodiment.

Referring to FIG. 6, the battery pack according to still another embodiment includes at least one battery cell (not shown), a protection circuit board 420 electrically connected to the battery cell, and a thermistor 430 provided in the protection circuit board 420.

The protection circuit board 420 may be connected to the battery cell through conductive tabs. The protection circuit board 420 may basically include an insulation layer 421 having a first thermally conductive pattern 422 formed on a first surface 421a thereof, specifically further extending from lower portions of sensing lines 212, a second thermally conductive pattern 423 formed on a second surface 421b opposite to the first surface 421a and corresponding to the first thermally conductive pattern 422, and a via 424 corresponding to the first and second thermally conductive patterns 422 and 423 and connecting the first and second thermally conductive patterns 422 and 423 to each other while passing through the insulation layer 421 in a thickness direction of the insulation layer 421, i.e., between the first and second surfaces 421a, 421b.

The first thermally conductive pattern 422, the second thermally conductive pattern 423 and the via 424 may be made of a material having good thermal conductivity, e.g., nickel (Ni), copper (Cu), aluminum (Al), gold (Au), and equivalents thereof, like the thermally conductive pattern 322 of the previous embodiment, thereby transferring heat of the batter cell transferred from the sensing lines 212 to the thermistor 430.

The thermistor 430 may be formed on the second surface 421b of the insulation layer 421 of the protection circuit board 420 and may be spaced less than or equal to 3 mm apart from the second thermally conductive pattern 423. In addition, themaally conductive silicon may further be formed at outer peripheries of the thermistor 430 and the second thermally conductive pattern 423, thereby reducing heat loss when the heat is transferred.

Hereinafter, a configuration of a battery pack according to still another embodiment will be described. FIG. 7 illustrates a cross-sectional view of a state in which a thermistor is connected to a protection circuit board in a battery pack according to still another embodiment.

Referring to FIG. 7, the battery pack according to still another embodiment includes at least one battery cell (not shown), a protection circuit board 520 electrically connected to the battery cell, and a thermistor 530 provided in the protection circuit board 520. The electrodes of the temperature sensitive element are displayed (531 and 532).

The protection circuit board 520 may basically include an insulation layer 521 and includes a thermally conductive pattern 522 formed on a first surface 521a, specifically further extending from lower portions of sensing lines 212, and a via 524 corresponding to a region of the thermally conductive pattern 522 while passing through the insulation layer 521 in a thickness direction of the insulation layer 521, i.e., between the first second 521a and a second surface 521b. Unlike in the previous embodiment, the battery pack according to still another embodiment is not provided with a separate thermally conductive pattern on the second surface 521b opposite to the first surface 521a of the insulation layer 521. The thermally conductive pattern 522 and the via 524 may also be made of a material having good thermal conductivity, e.g., nickel (Ni), copper (Cu), aluminum(Al), gold (Au), or equivalents thereof.

The thermistor may be is formed at a region corresponding to the thermally conductive pattern 522 on the second surface 521b of the insulation layer 521 of the protection circuit board. The thermistor 530 may be positioned above the via 524. Accordingly, the heat of the battery cell may be transferred through the sensing lines 212, the thermally conductive pattern 522 and the via 524. In addition, a thermally conductive silicon may be further formed on the outer periphery of the thermistor 530, thereby reducing the loss of heat transferred to the thermistor 530.

By way of summation and review, a battery pack according to one or more embodiments may include a chip thermistor simply formed in the vicinity of a region where a negative electrode tab of a prismatic battery cell is connected to a protection circuit board without a wire structure, thereby reducing the manufacturing process steps and transmitting heat of the battery cell from a negative electrode tab of the battery cell to the thermistor adjacent to the negative electrode tab without loss.

In addition, a battery pack according to one or more embodiments may include a chip thermistor formed in the vicinity of a region where a conductive tab connecting cylindrical battery cells and a protection circuit board are connected to each other, thereby reducing the manufacturing process steps and transmitting heat of the battery cells without loss.

Example embodiments have been disclosed, herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details ma be made without departing from the spirit and scope of the present invention as set forth in the following claims.

What is claimed is:

1. A battery pack, comprising:
at least one battery cell having a first conductive tab and to second conductive tab;
a protection circuit hoard electrically connected to the first and second conductive tabs; and
a temperature sensitive element on the protection circuit board adjacent, but electrically insulated from, a connection region where at least one of the first and second conductive tabs is connected to the protection circuit board, the connection region being between the temperature sensitive element and the battery cell.

2. The battery pack as claimed in claim 1, wherein the second conductive tab outputs more heat than the first conductive tab and no other thermally radiating elements are between the temperature sensitive element and the second conductive tab.

3. The battery pack as claimed in claim 1, wherein the second conductive tab is a negative electrode tab and the temperature sensitive element is closer to the negative electrode tab than to a positive electrode tab.

4. The battery pack as claimed in claim 1, wherein a smallest distance between the temperature sensitive element and the connection region is equal to or less than 3 mm.

5. The battery pack as claimed in claim 1, wherein the at least one battery cell include a plurality of battery cells connected to each other, the first conductive tab being a high current line connecting adjacent battery cells and the second conductive tab being a sensing line connecting adjacent battery cells.

6. The battery pack as claimed in claim 5, wherein the temperature sensitive element is closer to the sensing line than to the high current line.

7. The battery pack as claimed in claim 5, further comprising a thermally conductive pattern extending from the connection region of the sensing line towards, but not contacting, the temperature sensitive element.

8. The battery pack as claimed in claim 7, wherein the thermally conductive pattern is narrower than the connection region.

9. The battery pack as claimed in claim 1, wherein the connection region is a first thermally conductive pattern on a first surface of the protection circuit board and the temperature sensitive element is on one of the first surface and a second surface of the protection circuit board.

10. The battery cell as claimed in claim 9, further including a second thermally conductive pattern on the second surface, the temperature sensitive element being adjacent, but electrically insulated from, the second thermally conductive pattern, and thermally conductive vias extending through the protection circuit board between the first thermally conductive pattern and the second thermally conductive pattern.

11. The battery pack as claimed in claim 10, wherein at least one of the temperature sensitive element and the second thermally conductive pattern includes to thermally conductive silicon therebetween.

12. The battery pack as claimed in claim 9, further comprising:
thermally conductive vias extending through the protection circuit board to them couple the temperature sensitive element and the connection region.

13. The battery cell as claimed in claim 12, further including a second thermally conductive pattern on the second surface, the temperature sensitive element being adjacent, but electrically insulated from, the second thermally conductive pattern, wherein the thermally conductive vias extend between the first thermally conductive pattern and the second thermally conductive pattern.

14. The battery cell as claimed in claim 13, wherein the temperature sensitive element is spaced apart front the second thermally conductive pattern by 3 mm or less.

15. The battery cell as claimed in claim 13, wherein the temperature sensitive element is in physical contact with the thermally conductive vias.

16. The battery cell as claimed in claim 15, wherein the temperature sensitive element is in physical contact with the thermally conductive vias without electrical contact there between.

17. The battery cell as claimed in claim 1, further comprising a thermally conductive silicon between the temperature sensitive element and the protection circuit board.

18. The battery cell as claimed in claim 17, wherein the thermally conductive silicon extends along both ends of the temperature sensitive element parallel the connection region.

19. The battery pack as claimed in claim 1, wherein the temperature sensitive element includes a thermally conductive silicon between the temperature sensitive element and the connection region.

20. The battery pack as claimed in claim 1, wherein the temperature sensitive element is a thermistor.
